(19) United States
(12) Patent Application Publication
(10) Pub. No.: US 2002/0101393 A1
(43) Pub. Date: Aug. 1, 2002

(54) Communication network for outdoor signs II

(76) Inventor: Clarence Harold Bandura, Los Angeles, CA (US)

Correspondence Address: Clarence H. Bandura, P.O. Box 811691, Los Angeles, CA, 90017, US

(21) Appl. No.: 09/754,895

(22) Filed: Jan. 4, 2001

(51) Int. Cl. G09G 3/00

(52) U.S. Cl. 345/30

(57) ABSTRACT

Electronic communication either sending or receiving data (text or graphics) via wireless technology: satellite, virtual blanking intervals, microwave, or radio frequencies provides a means to exchange advertising data.

The internet or any part thereof i.e. intranet or individual computer(s)is used for the composition of text and graphics and subsequently directed to one or all of the wireless technologies as mentioned in the above paragraph #1.

After the composition of the intended advertising message on the internet or computer(s) the carrier being one of the electronic systems described in paragraph #1 herein, would display the intended word or picture—electronically on outdoor signs.

### BACKGROUND OF INVENTION

Communication networking for outdoor signs was a limited application.

### DETAILED DESCRIPTION OF THE PREFERRED EMBODIMENT

Electronic outdoor signs are networked with this invention via: broadcast television, virtual blanking intervals, radio frequency, satellite, microwave, or other wireless electronic signals thereby enabling the sending and exchange of data for display purposes.

Secondarily, composition of the desired message is performed on: computers either through an internet/intranet connection and or a singular computer which can then be previewed but has no direct connection to outdoor signs. After previewing the desired message is sent either via wireless or hardwired transmission to one or all of the wireless technologies as described in paragraph #1. Display times and intervals can be adjusted to suit the desired area or zones by the advertiser and payment can be arranged on the internet or computer.

Ultimately the desired message is displayed on outdoor signs: billboards, parking lot signs, sidewalk signs, bus shelters and other outdoor signage.

### SUMMARY

Through wireless technologies wide area or targeted data transmissions is more effective for display purposes. Also timed display intervals and zoned areas are implemented with more flexibility and faster message interchange. Cost reduction can also be a factor with wireless technologies due to lessened hard-wiring. Wireless networking combined with the internet provide a faster and more accessable implementation of text and graphics for outdoor signs.

I claim:

1) Electronic communication and networking of data for display on outdoor signs.

2) communication and data exchange as claimed in claim 1 via communication systems being satellite, television broadcasting, virtual blanking intervals, radio frequency, microwave, or other electronic or wireless signals.

3) a communications link to claim 2 (claim 2 being wireless) and connected to the internet, intranet, computer or computers via wireless or hardwired.

4) data composition on the internet or computer(s) as in claim 3 to include designated areas or zone(s)of the outdoor sign locations.

5) data composition as claimed in claim 4 to include to include timed intervals of display.

6) data composition as claimed in claim 4 to include text and or graphics.

7) virtual blanking intervals as claimed in claim 2 to include video transmission and data for outdoor signs.

8) one or two way communication with the internet and the technologies in claim 2 and/or one or two way communication with outdoorsign(s) and the described wireless technologies therein.
